(19) United States
(12) Patent Application Publication
(10) Pub. No.: US 2018/0293591 A1
(43) Pub. Date: Oct. 11, 2018

(54) System and Method for Authenticating Components Using Dual Key Authentication

(71) Applicant: General Electric Company, Schenectady, NY (US)

(72) Inventor: Thomas Graham Spears, Springdale, OH (US)

(21) Appl. No.: 15/479,389

(22) Filed: Apr. 5, 2017

(51) Int. Cl. G06Q 30/00; H04L 9/14; G06K 19/14; B33Y 50/02; G05B 19/042; B29C 67/00; B33Y 10/00

(52) U.S. Cl. CPC G06Q 30/0185; H04L 9/14; G06K 19/14; B33Y 50/02; G05B 2219/49023; B29C 67/0088; B33Y 10/00; G06Q 2220/00; G05B 19/0426

(57) ABSTRACT

A system and method for manufacturing and authenticating an additively manufactured component are provided. The method includes additively manufacturing the component including a first component identifier. A second component identifier is generated using the first component identifier and an encryption key. The second component identifier is additively manufactured onto the component and the first and second component identifiers are stored in a database as an authenticating pair. An end user may determine that a component is authentic if it contains a first component identifier and a second component identifier that match an authenticating pair from the database.

### FIELD

The present subject matter relates generally to additively manufactured components, and more particularly, to systems and methods for authenticating additively manufactured components including features for improved part identification or counterfeit prevention.

### BACKGROUND

Original equipment manufacturers (OEMs) in a variety of industries have an interest in ensuring that replacement components used with their products or equipment are manufactured according to standards set and controlled by the OEM. Using the aviation industry as an example, the manufacturer of a gas turbine engine, as well as the airlines and the passengers that rely on them, can be exposed to serious risks if counterfeit or replica replacement parts are readily available for and installed on these engines.

For example, such counterfeit components can pose a severe risk to the integrity of the gas turbine engines or may otherwise result in a variety of problems for the OEM and the end user. More specifically, OEM components may require rigorous attention to detail to ensure sound material properties and capabilities for the specific application as well as sophisticated inspections to verify the component performance. OEMs cannot ensure the integrity or compatibility of counterfeit parts, which may result in dangerous engine operation and increase the risk of potential failure.

In addition, counterfeit parts compromise the OEMs ability to control the quality associated with their products. For example, inexpensive replicas and inferior components on the market are a real threat, both to the engines on which they are installed and to the reputation of the OEM. Moreover, failure of a gas turbine engine due to a counterfeit replacement component might subject the OEM to misdirected legal liability and OEMs may lose a significant revenue stream by not being able to control the sale of OEM replacement components.

Additive manufacturing technologies are maturing at a fast pace. For example, very accurate additive manufacturing printers using a variety of materials, such as metals and polymers, are becoming available at decreasing costs. In addition, improved scanning technologies and modeling tools are now available. As a result, certain OEMs are beginning to use such technologies to produce original and replacement parts. However, the advance of additive manufacturing technologies also results in a lower barrier to entry into the additive manufacturing space. Therefore, replacement components may be more easily reverse engineered and copied, and there is an increased risk of third parties manufacturing and installing counterfeit components on OEM equipment, such as a gas turbine engine, resulting in the dangers described briefly above.

There is thus a need for a technology that allows genuine parts to be distinguished from counterfeits to ensure that parts created through additive manufacturing cannot be duplicated by an unauthorized third party and passed off as genuine OEM parts. Accordingly, systems and methods for authenticating additively manufactured components to distinguish genuine parts from counterfeit parts would be useful.

### BRIEF DESCRIPTION

Aspects and advantages of the invention will be set forth in part in the following description, or may be obvious from the description, or may be learned through practice of the invention.

In one exemplary embodiment of the present disclosure, a method of additively manufacturing a component is provided. The method includes additively manufacturing the component including a first component identifier and obtaining data indicative of the first component identifier. The method further includes generating, using the first component identifier and an encryption key, a second component identifier and additively manufacturing the second component identifier onto the component.

In another exemplary aspect of the present disclosure, a system for authenticating an additively manufactured component is provided. The system includes one or more processors and one or more memory devices, the one or more memory devices storing computer-readable instructions that when executed by the one or more processors cause the one or more processors to perform operations. The operations include obtaining data indicative of a first component identifier of the component and generating, using the first component identifier and an encryption key, a second component identifier. The method further includes additively manufacturing the second component identifier onto the component.

In still another exemplary aspect of the present disclosure, a method of authenticating an additively manufactured component is provided. The method includes obtaining a first component identifier and a second component identifier of the component. The method further includes communicating the first component identifier and the second component identifier to an authenticating entity, the authenticating entity having access to a database including a plurality of authenticating pairs. The method further includes receiving an indication from the authenticating entity that the component is authentic if the first component identifier and the second component identifier correspond to one of the plurality of authenticating pairs.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an additively manufactured component according to an exemplary embodiment of the present subject matter.

FIG. 2 provides a cross sectional view of the exemplary component of FIG. 1, taken along Line 2-2 of FIG. 1.

FIG. 3 is a method for manufacturing a component according to an exemplary embodiment of the present subject matter.

FIG. 4 is a method for authenticating a component according to an exemplary embodiment of the present subject matter.

FIG. 5 depicts certain components of an authentication system according to example embodiments of the present subject matter.

Repeat use of reference characters in the present specification and drawings is intended to represent the same or analogous features or elements of the present invention.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The present disclosure is generally directed to a system and method for manufacturing and authenticating an additively manufactured component. The method includes additively manufacturing the component including a first component identifier. A second component identifier is generated using the first component identifier and an encryption key. The second component identifier is additively manufactured onto the component and the first and second component identifiers are stored in a database as an authenticating pair. An end user may determine that a component is authentic if it contains a first component identifier and a second component identifier that match an authenticating pair from the database.

In general, the components described herein may be manufactured or formed using any suitable process. However, in accordance with several aspects of the present subject matter, these components may be formed using an additive-manufacturing process, such as a 3-D printing process. The use of such a process may allow the components to be formed integrally, as a single monolithic component, or as any suitable number of sub-components. In particular, the manufacturing process may allow these components to be integrally formed and include a variety of features not possible when using prior manufacturing methods. For example, the additive manufacturing methods described herein enable the manufacture of components having various features, configurations, thicknesses, materials, densities, surface variations, and identifying features not possible using prior manufacturing methods. Some of these novel features are described herein.

As used herein, the terms “additively manufactured” or “additive manufacturing techniques or processes” refer generally to manufacturing processes wherein successive layers of material(s) are provided on each other to “build-up,” layer-by-layer, a three-dimensional component. The successive layers generally fuse together to form a monolithic component which may have a variety of integral sub-components. Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or manufacturing technology. For example, embodiments of the present invention may use layer-additive processes, layer-subtractive processes, or hybrid processes.

Suitable additive manufacturing techniques in accordance with the present disclosure include, for example, Fused Deposition Modeling (FDM), Selective Laser Sintering (SLS), 3D printing such as by inkjets and laserjets, Sterolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Selective Laser Melting (DSLM), Selective Laser Melting (SLM), Direct Metal Laser Melting (DMLM), and other known processes.

The additive manufacturing processes described herein may be used for forming components using any suitable material. For example, the material may be plastic, metal, concrete, ceramic, polymer, epoxy, photopolymer resin, or any other suitable material that may be in solid, liquid, powder, sheet material, wire, or any other suitable form. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, and nickel or cobalt based superalloys (e.g., those available under the name Inconel® available from Special Metals Corporation). These materials are examples of materials suitable for use in the additive manufacturing processes described herein, and may be generally referred to as “additive materials.”

In addition, one skilled in the art will appreciate that a variety of materials and methods for bonding those materials may be used and are contemplated as within the scope of the present disclosure. As used herein, references to “fusing” may refer to any suitable process for creating a bonded layer of any of the above materials. For example, if an object is made from polymer, fusing may refer to creating a thermoset bond between polymer materials. If the object is epoxy, the bond may be formed by a crosslinking process. If the material is ceramic, the bond may be formed by a sintering process. If the material is powdered metal, the bond may be formed by a melting or sintering process. One skilled in the art will appreciate that other methods of fusing materials to make a component by additive manufacturing are possible, and the presently disclosed subject matter may be practiced with those methods.

In addition, the additive manufacturing process disclosed herein allows a single component to be formed from multiple materials. Thus, the components described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

An exemplary additive manufacturing process will now be described. Additive manufacturing processes fabricate components using three-dimensional (3D) information, for example a three-dimensional computer model, of the component. Accordingly, a three-dimensional design model of the component may be defined prior to manufacturing. In this regard, a model or prototype of the component may be scanned to determine the three-dimensional information of the component. As another example, a model of the component may be constructed using a suitable computer aided design (CAD) program to define the three-dimensional design model of the component.

The design model may include 3D numeric coordinates of the entire configuration of the component including both external and internal surfaces of the component. For example, the design model may define the body, the surface, and/or any surface features such as irregularities, component identifiers, localized variations, or datum features, as well as internal passageways, openings, support structures, etc. In one exemplary embodiment, the three-dimensional design model is converted into a plurality of slices or segments, e.g., along a central (e.g., vertical) axis of the component or any other suitable axis. Each slice may define a thin cross section of the component for a predetermined height of the slice. The plurality of successive cross-sectional slices together form the 3D component. The component is then “built-up” slice-by-slice, or layer-by-layer, until finished.

In this manner, the components described herein may be fabricated using the additive process, or more specifically each layer is successively formed, e.g., by fusing or polymerizing a plastic using laser energy or heat or by sintering or melting metal powder. For example, a particular type of additive manufacturing process may use an energy beam, for example, an electron beam or electromagnetic radiation such as a laser beam, to sinter or melt a powder material. Any suitable laser and laser parameters may be used, including considerations with respect to power, laser beam spot size, and scanning velocity. The build material may be formed by any suitable powder or material selected for enhanced strength, durability, and useful life, particularly at high temperatures.

Each successive layer may be, for example, between about 10 μm and 200 μm, although the thickness may be selected based on any number of parameters and may be any suitable size according to alternative embodiments. Therefore, utilizing the additive formation methods described above, the components described herein may have cross sections as thin as one thickness of an associated powder layer, e.g., 10 μm, utilized during the additive formation process.

In addition, utilizing an additive process, the surface finish and features of the components may vary as need depending on the application. For example, the surface finish may be adjusted (e.g., made smoother or rougher) by selecting appropriate laser scan parameters (e.g., laser power, scan speed, laser focal spot size, overlap between passes, etc.) during the additive process, especially in the periphery of a cross-sectional layer which corresponds to the part surface. For example, a rougher finish may be achieved by increasing laser scan speed or decreasing the size of the melt pool formed, and a smoother finish may be achieved by decreasing laser scan speed or increasing the size of the melt pool formed. The scanning pattern and/or laser power can also be changed to change the surface finish in a selected area.

Notably, in exemplary embodiments, several features of the components described herein were previously not possible due to manufacturing restraints. However, the present inventors have advantageously utilized current advances in additive manufacturing techniques to develop exemplary embodiments of such components generally in accordance with the present disclosure. While the present disclosure is not limited to the use of additive manufacturing to form these components generally, additive manufacturing does provide a variety of manufacturing advantages, including ease of manufacturing, reduced cost, greater accuracy, etc.

In this regard, utilizing additive manufacturing methods, even multi-part components may be formed as a single piece of continuous metal, and may thus include fewer sub-components and/or joints compared to prior designs. The integral formation of these multi-part components through additive manufacturing may advantageously improve the overall assembly process. For example, the integral formation reduces the number of separate parts that must be assembled, thus reducing associated time and overall assembly costs. Additionally, existing issues with, for example, leakage, joint quality between separate parts, and overall performance may advantageously be reduced.

Also, the additive manufacturing methods described above enable much more complex and intricate shapes and contours of the components described herein. For example, such components may include thin additively manufactured layers and novel surface features. All of these features may be relatively complex and intricate for avoiding detection and/or impeding counterfeiting by a third party. In addition, the additive manufacturing process enables the manufacture of a single component having different materials such that different portions of the component may exhibit different performance characteristics. The successive, additive nature of the manufacturing process enables the construction of these novel features. As a result, the components described herein may exhibit improved performance and may be easily distinguished from replicas or counterfeit components.

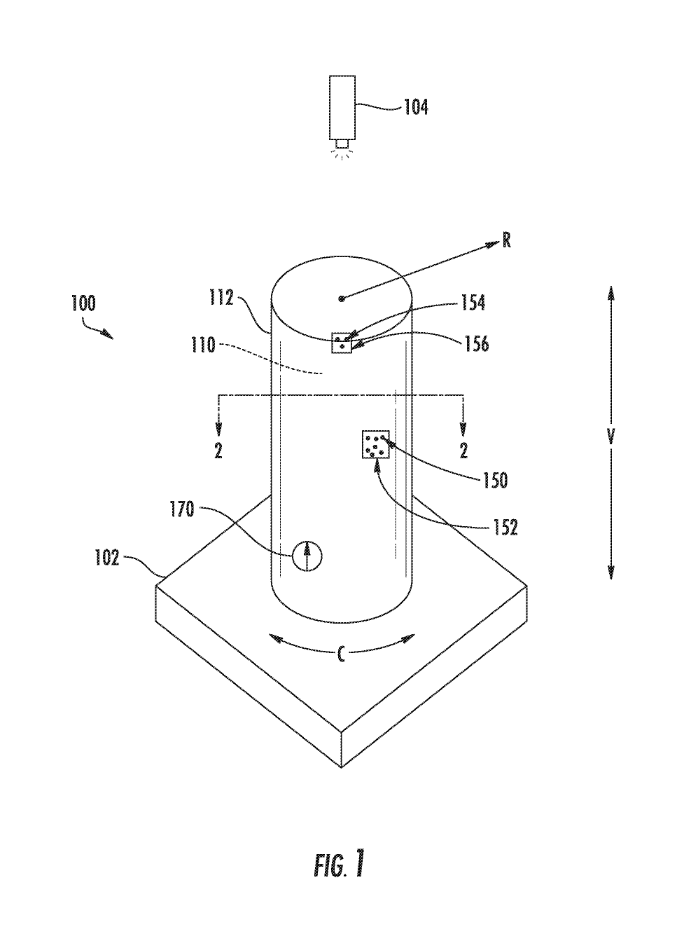

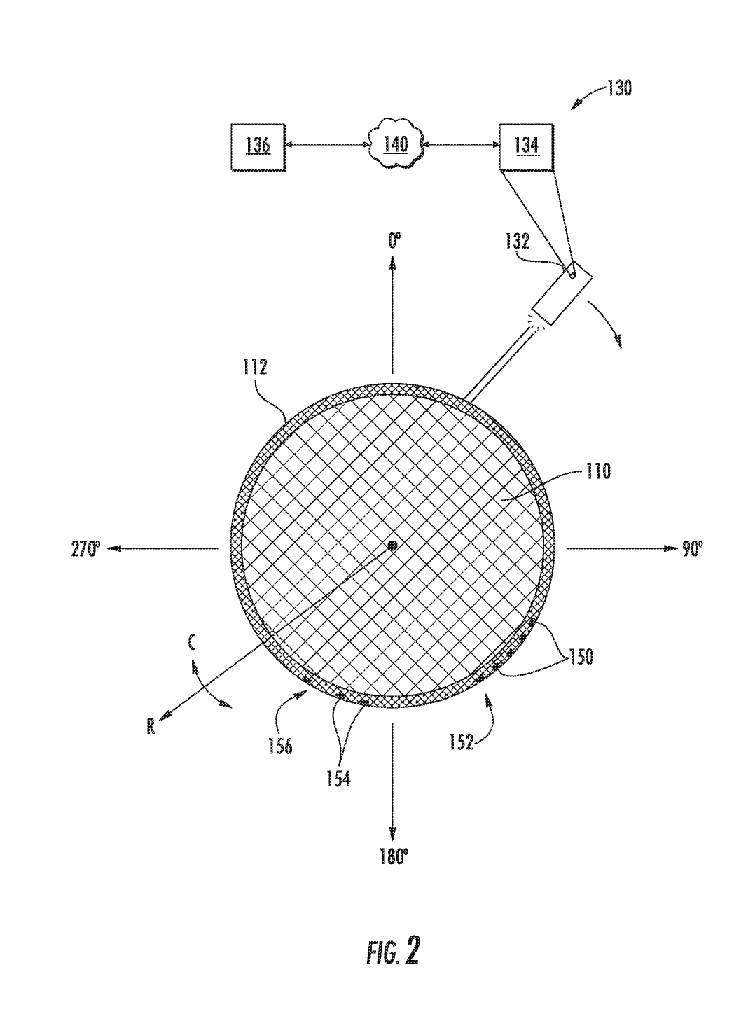

Referring now to FIGS. 1 through 2, an additively manufactured component 100 according to an exemplary embodiment of the present subject matter is provided. More specifically, FIG. 1 provides a perspective view of component 100 and FIG. 2 provides a cross sectional view of component 100, taken along Line 2-2 of FIG. 1. For the purpose of explaining aspects of the present subject matter, component 100 is a simple, solid cylinder. However, it should be appreciated that the additive manufacturing methods described herein may be used to form any suitable component for any suitable device, regardless of its material or complexity. As illustrated, component 100 generally defines a radial direction R, a circumferential direction C, and a vertical direction V.

Also illustrated in FIG. 1 is an additive manufacturing platform 102 and an energy source 104, as may be used according to any of the additive manufacturing methods described above. For example, component 100 may be constructed by laying a powder bed onto platform 102 and selectively fusing the powder bed at desired locations using energy source 104 to form a layer of component 100. Platform 102 may be lowered along the vertical direction V after each layer is formed and the process may be repeated until component 100 is complete.

Referring to FIG. 2, a cross sectional view of component 100 taken along Line 2-2 (or more specifically, a plane corresponding to this line) will be described. It should be appreciated that FIG. 2 illustrates a top view of a single additively manufactured layer of component 100 having a finite thickness. As illustrated, component 100 includes a cross sectional layer 110. Cross sectional layer 110 may generally define an interior body layer and a surface 112. As used herein, “interior body layer” may refer to any structure, body, surface, base layer, or other portion of component 100 on which a surface may be formed. In this regard, for example, component 100 includes surface 112 that is formed around cross sectional layer 110, i.e., along a perimeter or periphery of cross sectional layer 110 along the circumferential direction C. As used herein, “surface” may refer to the periphery of one or more cross sectional layer 110 of component 100, e.g., formed on an otherwise exposed interior body layer.

According to the illustrated embodiment, cross sectional layer 110 and surface 112 may be formed at different energy levels and may have different structural characteristics. As used herein, an “energy level” of an energy source is used generally to refer to the magnitude of energy the energy source delivers to a particular point or region of component 100. For example, if the energy source is a laser or an electron beam, the energy level is generally a function of the power level and the scan speed of the laser or electron beam. As used herein, “scan speed” is used generally to refer to the linear velocity of the energy source along a surface of the additively manufactured component. Notably, the energy level of an energy source directed toward a powder bed may also be manipulated by adjusting the scanning strategy, e.g., by increasing or decreasing the overlap between adjacent passes of the energy source over the powder bed.

Adjusting the energy level of energy source 104 can enable the formation of component 100 with different regions having different densities and structural properties. For example, a higher energy level may be achieved by increasing the power level of energy source 104 (e.g., in Watts), decreasing its scan speed, or increasing the overlap between adjacent passes of energy source 104 to direct more energy onto a single area of the powder bed. By contrast, a lower energy level may be achieved by decreasing the power level of energy source 104, increasing its scan speed, or decreasing the overlap between adjacent passes of energy source 104 to direct less energy onto a single area of the powder bed.

According to the exemplary embodiment, component 100 is formed by moving energy source 104 (or more specifically, a focal point of the energy source 104, as shown in FIG. 1) along a powder bed placed on platform 102 to fuse together material to form component 100. According to the exemplary embodiment, a first energy level (e.g., a higher energy level) is used to form cross sectional layer 110 and a second energy level (e.g., a lower energy level) is used to form surface 112. It should be appreciated that this is only one exemplary construction of component 100. According to alternative embodiments, components formed using the methods described herein may have any suitable size and number of sections formed using any suitable energy source, at any suitable energy level, and having any suitable scanning strategy.

According to exemplary embodiments of the present subject matter, component 100 may include a component identifier that may be used by the component manufacturer, an end user, or another third party to authenticate or positively identify component 100. For example, the component identifier may be integrated with component 100 such that the component identifier remains associated with component 100 throughout the lifetime of component 100. The component identifier may be unique to a specific component, may be associated with a group of components manufactured at the same time, or may refer to a type of component in general.

Exemplary component identifiers may be any sequence of features such as bumps, divots, or other surface aberrations that contain or define encoded information in a manner analogous to a printed serial number, a bar code, or a QR code, e.g., for uniquely identifying component 100. In addition, such component identifiers may be localized component materials, configurations, densities, surface variations, or other features suitable for generating the component identifier when interrogated with some type of scanner, such as described below. The component identifiers may be inherent in the manufactured component (e.g., a pattern of surface roughness) or may be intentionally designed and manufactured into the component. The exemplary component identifiers described herein are used only to illustrate aspects of the present subject matter and are not intended to limit its scope.

In order to read the component identifiers to identify, distinguish, or authenticate component 100, the manufacturer or an authorized end user may use some suitable scanning device, probe, or detector for reading the component identifier. For example, referring to FIG. 2 an authentication system 130 for authenticating components will be described according to exemplary embodiments of the present subject matter.

As described in more detail below, authentication system 130 may include a scanning device 132 that is configured for reading the component identifier of component 100. In general, the process of using scanning device 132 for reading, mapping, or otherwise obtaining useful data regarding the component identifier of component 100 is referred to herein as “interrogation” of component 100. Scanning device 132 may pass over surface 112 of component 100 in any suitable manner for interrogating component 100.

According to the illustrated embodiment, scanning device 132 includes a controller 134 which is generally configured for receiving, analyzing, transmitting, or otherwise utilizing data acquired by scanning device 132. Controller 134 can include various computing device(s) (e.g., including processors, memory devices, etc.) for performing operations and functions, as described herein. For reasons described in more detail below, scanning device 132, or more specifically, controller 134, may further be in communication with a database or remote computing system 136, e.g., via a network 140, and may be configured for transmitting or receiving information related to component 100, e.g., such as its component identifier.

According to exemplary embodiments of the present subject matter, the component identifier relies on dual key encryption for enhanced security. In this regard, for example, each component has two component identifiers that collectively identify the component. More specifically, according to the illustrated embodiment, component 100 includes a first component identifier 150 located in a first identifying region 152 and a second component identifier 154 located in a second identifying region 156. As described in more detail below, second component identifier 154 is generated using first component identifier 150 and an encryption key or algorithm. According to exemplary embodiments, the manufacturer could control the encryption key and store the component identifiers from all authentic components in a database as authenticating pairs. In this manner, the authenticity of a component may be determined by reading first component identifier 150 and second component identifier 154 and searching the database to determine whether there is a matching authenticating pair. Although the description herein refers to the use of a pair of component identifiers, it should be appreciated that more than two component identifiers may be used according to alternative embodiments. In this regard, for example, a component may have three component identifiers, two of which are defined using one or more encryption keys or algorithms. These three component identifiers may be stored in a database as an authenticating set in the same manner as authenticating pairs, as described herein.

As described herein, first component identifier 150 and second component identifier 154 are a pattern or sequence of surface irregularities that correspond to or define a component identifier. In this regard, the surface irregularities may be any identifiable deviation from surface 112 of component 100 which may be used to identify, authenticate, or distinguish component 100. For example, the surface irregularities may correspond to a printed serial number, bar code, a QR code, or any other sequence of bump, divots, or other surface aberrations.

The surface irregularities which define component identifiers 150, 154 may be formed, for example, by manipulating the energy level of energy source 104. For example, these surface irregularities may be bumps formed by increasing the energy level of energy source 104 at select locations. In this regard, for example, the power of energy source 104 may be increased or the scan speed may be slowed to fuse more powder. By contrast, these surface irregularities may be divots formed by decreasing an energy level of energy source 104 at select locations. In this regard, for example, the power of energy source 104 may be decreased or the scan speed may be increased to fuse less powder.

According to the exemplary embodiment, scanning device 132 may generally be configured for measuring surface height variations relative to a nominal surface level. In this regard, for example, scanning device 132 may be an optical sensor (e.g., a laser), a tactile sensor (e.g., a measurement probe or contact profilometer), or any other suitable device for sensing, measuring, or reading a surface of a component. Scanning device 132 may pass over surface 112 of component 100 in any suitable manner for mapping surface 112, or otherwise rendering some useful data regarding surface 112 of component 100, e.g., the surface roughness, material variations, or the pattern formed by one or more surface irregularities.

Although a pattern of surface irregularities are used herein generally to define component identifiers 150, 154, it should be appreciated that component identifier 150, 154 may be any other suitable indicia for positively identifying component 100. In this regard, for example, first component identifier 150 and second component identifier 154 could alternatively be any suitably unique identifying feature of component 100. In addition, first component identifier 150 and second component identifier 154 can be defined using different methods. For example, according to one exemplary embodiment, first component identifier 150 is a pattern of surface roughness within first identifying region 152 and second component identifier 154 is a sequence of surface irregularities or a pattern of contrast agents selectively deposited within second identifying region 156. Similarly, it should be appreciated that scanning device 132 may be any suitable device for reading, measuring, or interrogating component identifier 150, 154.

Thus, according to alternative embodiments, component identifiers 150, 154 may be defined by the acoustic wave responses of specific regions of component 100. In this regard, for example, first identifying region 152 and second identifying region 156 may each contain a unique structure, material type, pattern, or density configured for generating a unique acoustic wave response that corresponds to a component identifier when interrogated by scanning device 132. For example, by selectively depositing material having different sonic propagation properties than portions of the surrounding material, the acoustic propagation properties of a region may be adjusted to generate a unique acoustic wave response when that region is excited with an acoustic vibration or wave. In this regard, one or more materials may be introduced or otherwise deposited on component 100 using chemical vapor deposition to adjust its acoustic wave response and define component identifiers 150, 154. According to other exemplary embodiments, the sonic propagation properties of a material may be adjusted by laser shock peening, e.g., to create local variations in density and/or hardness. Other methods of introducing such features are also possible.

According to other exemplary embodiments, component identifiers 150, 152 may be defined by localized density variations within a region of component 100. In this regard, for example, scanning device 132 may be an x-ray computed tomography (x-ray CT) device configured for mapping localized variations in the density of component 100. Alternatively one or more contrast agents may be deposited on a surface of the component during or after manufacturing. These contrast agents may include x-ray, infrared, ultraviolet, radioactive, or other suitable contrast agent that are configured for generating a unique component identifier when interrogated by a specific scanner, probe, or other suitable detector.

Whatever type of component identifiers are used and how they are interrogated, first component identifier 150 and second component identifier 154 are related to each other by an encryption key. According to an exemplary embodiment of the present subject matter, the method for generating encrypted dual component identifiers includes using a computer program running a chaotic system to generate second component identifier 154 using first component identifier 150 as a seed. Although several exemplary methods of generating second component identifier 154 will be described below, it should be appreciated that these methods are only examples and any suitable manner of generating a unique second component identifier 154 may be used.

According to one exemplary embodiment, first component identifier 150 may be a serial number or may be converted into a serial number. The encryption method may use a classic logistic map governed by the following equation: xₙ₊₁=r*xₙ*(1−xₙ), where x0 is the inverse of the serial number associated with first component identifier 150 and r is a parameter between 3.9 and 4. Using such a classic logistic map with first component identifier 150 as an initial input, any suitable arbitrary number of iterations produces a second serial number defining second component identifier 154.

Another method of generating second component identifier 154 is to use a double pendulum where first component identifier 150 is split in half and inverted. The arctangent of each inverted number is then used as the initial angles between the pendula. The double pendulum system may be allowed to continue for an arbitrarily large amount of time and the angles between the pendula at that time may be concatenated to form second component identifier 154.

Regardless of the encryption algorithm used or the method of generating second component identifier 154 from first component identifier 150, the manufacturer may control this “encryption key” and thus the rules for associating first component identifier 150 and second component identifier 154. The manufacturer may then additively manufacture second component identifier 154 onto component 100 and store first component identifier 150 and second component identifier 154 in a database as an authenticating pair. A party trying to form a counterfeit component would be unable to form a component having two component identifiers matching an authenticating pair from the database unless they had the encryption key or access to the database, both of which are controlled by the manufacturer.

An end user may authenticate a component using both the first component identifier and the second component identifier. More specifically, using component 100 as an example, the end user may obtain first component identifier 150 and second component identifier 154 using a suitable scanning device, as described herein. The end user may then transmit first component identifier 150 and second component identifier 154 to the manufacturer for authentication. The manufacturer may obtain and compare component identifiers 150, 154 to the authenticating pairs stored in the database. If first component identifier 150 and second component identifier 154 match an authenticating pair from the database, the component may be determined to be authentic. Thus, the manufacturer may provide an indication to the end user that the component is authentic.

According to exemplary embodiments, it may be desirable to make locating identifying regions 152, 156 more difficult, e.g., to avoid detection using conventional low-tech scanning means. Therefore, according to an exemplary embodiment, component identifiers 150, 154 may be small enough to be undetectable to the human eye or may require specialized scanning means to locate and interrogate. More specifically, for example, if component identifiers 150, 154 are defined by surface irregularities, those irregularities may have a size that is less than one millimeter. According to other exemplary embodiments, at least one of first component identifier 150 and second component identifier 154 is smaller than 50 micrometers such that it is not visible to the human eye.

According to an exemplary embodiment of the present subject matter, it may be desirable to include one or more additional features on component 100 which assist the manufacturer or an end user in locating first identifying region 152 and/or second identifying region 156 which contain first component identifier 150 and second component identifier 154, respectively. For example, as explained above, component identifiers 150, 154 may not be visible to the human eye. Thus, to avoid the need to scan the entire surface 112 to locate and interrogate component identifiers 150, 154, one or more datum features may be used as a reference from which an authorized end user may find identifying regions 152, 156.

More specifically, referring again to FIG. 1, component 100 further includes a datum feature 170 that is visible to the human eye or otherwise easily detectable. For example, according to the exemplary embodiment, datum feature 170 has a size that is greater than about one millimeter. Moreover, datum feature 170 may indicate both a position and an orientation of component 100. According to the illustrated embodiment, datum feature 170 is formed within surface 112 of component 100. However, it should be appreciated that according to alternative embodiments, datum feature 170 may be formed within the interior of component 100 or cross sectional layer 110 and/or within both the interior of cross sectional layer 110 and surface 112 of component.

Datum feature 170 is located at a predetermined location relative to first identifying region 152 and second identifying region 156—and thus component identifiers 150, 154. In this manner, an authorized third party who knows the relative positioning of datum feature 170 and identifying regions 152, 156 may easily locate datum feature 170 and use it as a reference for locating and interrogating these regions to read component identifiers 150, 154. More specifically, an authenticating party may know where to position and how to orient scanning device 132 to interrogate identifying regions 152, 156.

It should be appreciated that component 100 is described herein only for the purpose of explaining aspects of the present subject matter. For example, component 100 will be used herein to describe exemplary methods of manufacturing and authenticating additively manufactured components. It should be appreciated that the additive manufacturing techniques discussed herein may be used to manufacture other components for use in any suitable device, for any suitable purpose, and in any suitable industry. Furthermore, the encryption and authentication methods described herein may be used to identify, authenticate, or otherwise distinguish such components. Thus, the exemplary components and methods described herein are used only to illustrate exemplary aspects of the present subject matter and are not intended to limit the scope of the present disclosure in any manner.

Now that the construction and configuration of component 100 according to an exemplary embodiment of the present subject matter has been presented, an exemplary method 200 for forming a component according to an exemplary embodiment of the present subject matter is provided. Method 200 can be used by a manufacturer to form component 100, or any other suitable part or component. It should be appreciated that the exemplary method 200 is discussed herein only to describe exemplary aspects of the present subject matter, and is not intended to be limiting.

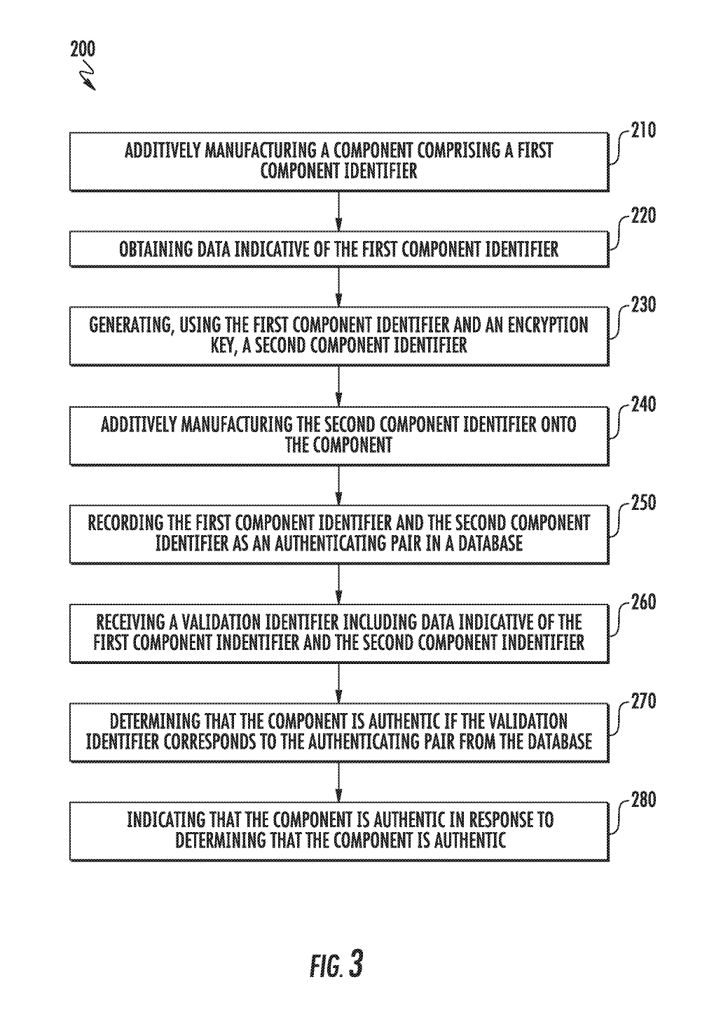

Referring now to FIG. 3, method 200 includes, at step 210, additively manufacturing a component comprising a first component identifier. This may include, for example, additively manufacturing an interior body layer and a surface, such as described above with respect to component 100. In addition, the first component identifier may be a printed serial number or QR code, a series of surface irregularities or density variations, selectively deposited contrast agents, materials that introduce localized variations in the conductivity or acoustic properties of the component, or any other suitable identifier.

For example, as explained above, surface irregularities may be introduced to the surface by selectively depositing and fusing additional powder layers or by manipulating the energy level of the energy source. Similarly, localized surface variations may be integrated into component 100 by selectively depositing material during an additive manufacturing process, through chemical vapor deposition, through laser shock peening, etc.

Method 200 further includes, at step 220, obtaining data indicative of the first component identifier. This may be achieved, for example, by using a scanning device to measure or read the first component identifier after it is formed. Alternatively, the first component identifier may be determined from the additive manufacturing program code. The first component identifier may also be manipulated or otherwise formatted such that the encryption methods described above may be applied to the first component identifier. For example, if the first component identifier is a sequence of localized surface variations or bumps having different heights, these bumps may be assigned numerical values and placed in an order or sequence to facilitate the encryption process.

Method 200 further includes, at step 230, generating, using the first component identifier and an encryption key, a second component identifier. This includes using any suitable encryption method or algorithm with the first component identifier as an input to generate the second component identifier. Several exemplary encryption methods are described above but are not intended to limit the scope of the present subject matter. After the second component identifier is generated, step 240 includes additively manufacturing the second component identifier onto the component.

As explained above, the first component identifier may be located within a first identifying region and the second component identifier may be located within a second identifying region. According to exemplary embodiments, the component further includes a datum feature which may be used to determine the specific position and orientation of the component. The datum feature may be useful in locating the first identifying region and the second identifying region and positioning a scanning device for interrogating the component, e.g., particularly when these regions and their respective component identifiers are not readily detectable.

Step 250 includes recording the first component identifier and the second component identifier as an authenticating pair in a database. In this regard, the manufacturer may maintain a database that contains authenticating pairs associated with every authentic component. By controlling the encryption method by which the second component identifiers are generated and the database in which authenticating pairs are stored, the manufacturer can maintain complete control over the process for authenticating components. Although the manufacturer is described herein as controlling and maintaining the database, it should be appreciated that the present subject matter is not so limited.

Thus, steps 210 through 250 may be generally used for querying or reading a component for identification data and storing that data for subsequent component validation, as described below with respect to steps 260 through 280. More specifically, a component is validated if it contains a first component identifier and a second component identifier that match an authenticating pair in the database. As used herein, these component identifiers “match” the authenticating pair if a positive identification or verification may be made between the component identifiers and the authenticating pair. In this regard, a 100% identical match is not required, as the component identifiers may have degraded or changed during the life of the component, there may be variations in scanner accuracy or calibration, etc. However, there should still be a sufficient resemblance between the component identifiers and the authenticating pair that a party may, with a reasonable degree of accuracy, determine that the component bearing the component identifiers is indeed the same component from which the authenticating pair was obtained and catalogued in the database.

Method 200 further includes, at step 260, receiving a validation identifier. As used in method 200, the validation identifier results from an interrogation of the first identifying region and the second identifying region of a component by a third party, such as an end user. The validation identifier thus includes data indicative of the first component identifier and the second component identifier. Thus, if the component is authentic, the validation identifier should match an authenticating pair stored in the manufacturer's database. At step 270, the validation identifier is compared to the authenticating pair (stored in the database), and step 280 includes determining that the component is authentic if the validation identifier matches the authenticating pair. According to some embodiments, the authenticating party may further provide an indication that the component is authentic in response to determining that the component is authentic.

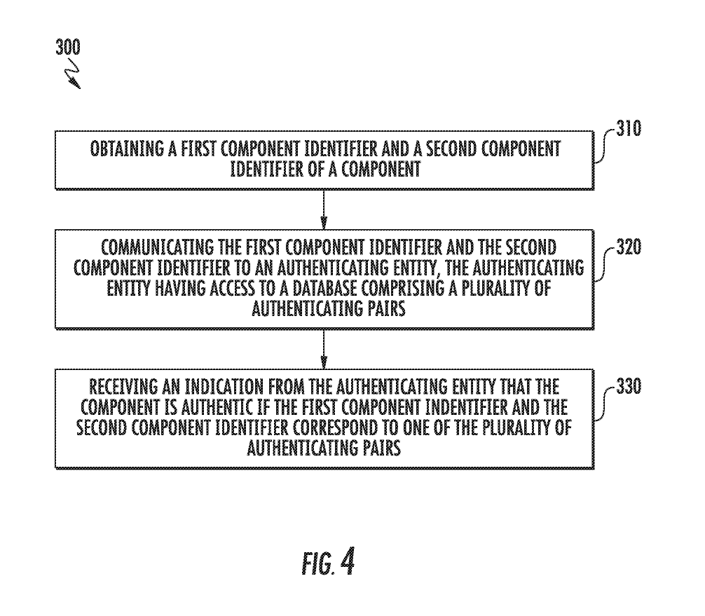

Referring now to FIG. 4, an exemplary method 300 for authenticating a component according to an exemplary embodiment of the present subject matter is provided. Method 300 can be used by a customer or end user of a component, e.g., such as the end user of component 100, for validating that the component is authentic and is not a counterfeit component. It should be appreciated that the exemplary method 300 is discussed herein only to describe exemplary aspects of the present subject matter, and is not intended to be limiting.

Method 300 includes, at step 310, obtaining a first component identifier and a second component identifier of a component. As explained above, this may be achieved by interrogating the component at a first identifying region and a second identifying region using a suitable scanning device. According to exemplary embodiments, using component 100 as an example, first identifying region 152 and second identifying region 156 may be located by locating datum feature 170 and using knowledge of its relative position to locate these regions.

Step 320 includes communicating the first component identifier and the second component identifier to an authenticating entity, the authenticating entity having access to a database comprising a plurality of authenticating pairs. The authenticating entity may be, for example, the manufacturer of the component or another party that measured and catalogued the authenticating pairs in the database. According to an exemplary embodiment, the authenticating pairs may be obtained from a database stored locally, e.g., on controller 134. Alternatively, the database may be remotely stored and may be accessed, for example, through remote computing system 136 via network 140.

Step 330 includes receiving an indication from the authenticating entity that the component is authentic if the first component identifier and the second component identifier correspond to one of the plurality of authenticating pairs. In this regard, for example, the manufacturer may receive the first component identifier and the second component identifier and perform a search within the database of authenticating pairs to determine whether there is a match. If the component is determined to be authentic, the manufacturer may then transmit a signal to the end user indicating that the component is authentic. By contrast, if the component identifier does not match an authenticating pair from the database, the manufacturer may provide an indication to the end user that the component might be a counterfeit.

As discussed herein, one or more portion(s) of methods 200 and 300 can be implemented by controller 134, by remote computing system 136, or both. Thus, for example, it should be appreciated that according to certain embodiments, the component authentication may be performed by a party other than the manufacturer, e.g., the end user. In such an embodiment, the end user may perform the authentication steps—i.e., obtaining the authenticating pairs, comparing the first component identifier and the second component identifier to the authenticating pairs, and making a determination regarding authenticity.

FIGS. 3 and 4 depict steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of methods 200, 300 are explained using component 100 as an example, it should be appreciated that these methods may be applied to authenticate any suitable component.

An additively manufactured component and a method for manufacturing and authenticating that component are described above. Using the additive manufacturing methods described herein, the component may include identifying features that are smaller, more complex, and more intricate than possible using prior manufacturing methods. In addition, these features may be difficult or impossible to detect, very difficult to reverse engineer, and nearly impossible reproduce, e.g., for the purpose of producing counterfeit products. For example, the first and second component identifiers may be designed to appear random and non-obvious. These features may further be formed such that they are not visible to the human eye and may be read using specialized interrogation methods directed to a specific identifying region of the component that is unknown to third parties. These features may be introduced during the design of the component, such that they may be easily integrated into components during the build process at little or no additional cost. The features may also serve as a robust identifier capable of withstanding high temperatures without degradation throughout the life of the component, with little or no impact on the quality of the component. Furthermore, these features may be authenticated through comparison with previously catalogued reference identifiers.

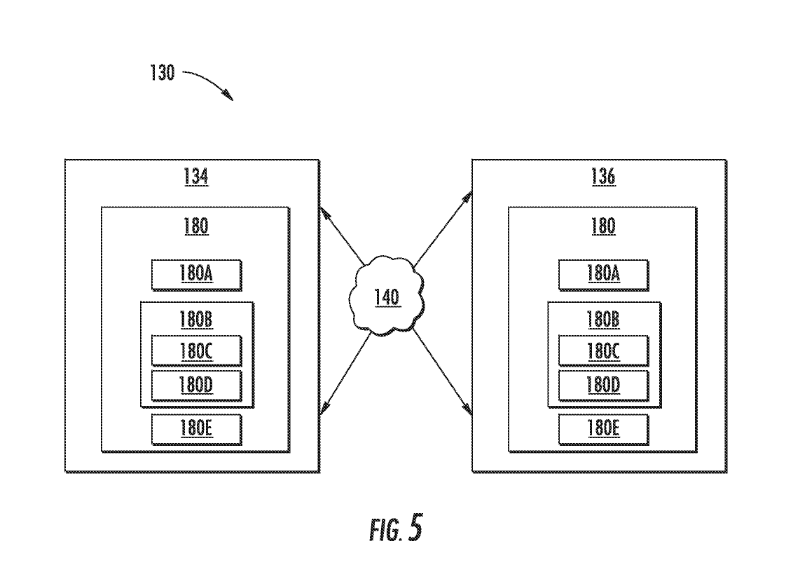

FIG. 5 depicts authentication system 130 according to example embodiments of the present disclosure. As described above, authentication system 130 can include one or more controllers 134 and/or remote computing systems 136, which can be configured to communicate via one or more network(s) (e.g., network(s) 140). According to the illustrated embodiment, remote computing system 136 is remote from controller 134. However, it should be appreciated that according to alternative embodiments, remote computing system 136 can be included with or otherwise embodied by controller 134.

Controller 134 and remote computing system 136 can include one or more computing device(s) 180. Although similar reference numerals will be used herein for describing the computing device(s) 180 associated with controller 134 and remote computing system 136, respectively, it should be appreciated that each of controller 134 and remote computing system 136 may have a dedicated computing device 180 not shared with the other. According to still another embodiment, only a single computing device 180 may be used to implement the methods described herein, and that computing device 180 may be included as part of controller 134 or remote computing system 136.

Computing device(s) 180 can include one or more processor(s) 180A and one or more memory device(s) 180B. The one or more processor(s) 180A can include any suitable processing device, such as a microprocessor, microcontroller, integrated circuit, an application specific integrated circuit (ASIC), a digital signal processor (DSP), a field-programmable gate array (FPGA), logic device, one or more central processing units (CPUs), graphics processing units (GPUs) (e.g., dedicated to efficiently rendering images), processing units performing other specialized calculations, etc. The memory device(s) 180B can include one or more non-transitory computer-readable storage medium(s), such as RAM, ROM, EEPROM, EPROM, flash memory devices, magnetic disks, etc., and/or combinations thereof.

The memory device(s) 180B can include one or more computer-readable media and can store information accessible by the one or more processor(s) 180A, including instructions 180C that can be executed by the one or more processor(s) 180A. For instance, the memory device(s) 180B can store instructions 180C for running one or more software applications, displaying a user interface, receiving user input, processing user input, etc. In some implementations, the instructions 180C can be executed by the one or more processor(s) 180A to cause the one or more processor(s) 180A to perform operations, as described herein (e.g., one or more portions of the methods described above). More specifically, for example, the instructions 180C may be executed to perform a comparison between an authenticating pair and component identifiers, to perform an authentication analysis, to transmit an indication of authenticity, etc. The instructions 180C can be software written in any suitable programming language or can be implemented in hardware. Additionally, and/or alternatively, the instructions 180C can be executed in logically and/or virtually separate threads on processor(s) 180A.

The one or more memory device(s) 180B can also store data 180D that can be retrieved, manipulated, created, or stored by the one or more processor(s) 180A. The data 180D can include, for instance, data indicative of reference identifiers associated with authentic additively manufactured components. The data 180D can be stored in one or more database(s). The one or more database(s) can be connected to controller 134 and/or remote computing system 136 by a high bandwidth LAN or WAN, or can also be connected to controller through network(s) 140. The one or more database(s) can be split up so that they are located in multiple locales. In some implementations, the data 180D can be received from another device.

The computing device(s) 180 can also include a communication interface 180E used to communicate with one or more other component(s) of authentication system 130 (e.g., controller 134 or remote computing system 136) over the network(s) 140. The communication interface 180E can include any suitable components for interfacing with one or more network(s), including for example, transmitters, receivers, ports, controllers, antennas, or other suitable components.

The network(s) 140 can be any type of communications network, such as a local area network (e.g. intranet), wide area network (e.g. Internet), cellular network, or some combination thereof and can include any number of wired and/or wireless links. The network(s) 140 can also include a direct connection between one or more component(s) of authentication system 130. In general, communication over the network(s) 140 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The technology discussed herein makes reference to servers, databases, software applications, and other computer-based systems, as well as actions taken and information sent to and from such systems. It should be appreciated that the inherent flexibility of computer-based systems allows for a great variety of possible configurations, combinations, and divisions of tasks and functionality between and among components. For instance, computer processes discussed herein can be implemented using a single computing device or multiple computing devices (e.g., servers) working in combination. Databases and applications can be implemented on a single system or distributed across multiple systems. Distributed components can operate sequentially or in parallel. Furthermore, computing tasks discussed herein as being performed at the computing system (e.g., a server system) can instead be performed at a user computing device. Likewise, computing tasks discussed herein as being performed at the user computing device can instead be performed at the computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of additively manufacturing a component, the method comprising:
additively manufacturing the component comprising a first component identifier;
obtaining data indicative of the first component identifier;
generating, using the first component identifier and an encryption key, a second component identifier; and
additively manufacturing the second component identifier onto the component.

2. The method of claim 1, further comprising recording the first component identifier and the second component identifier as an authenticating pair in a database.

3. The method of claim 2, further comprising:
receiving a validation identifier including data indicative of the first component identifier and the second component identifier; and
determining that the component is authentic if the validation identifier corresponds to the authenticating pair from the database.

4. The method of claim 3, wherein receiving the validation identifier comprises receiving the validation identifier from an end user or consumer.

5. The method of claim 1, wherein at least one of the first component identifier and the second component identifier is a surface roughness in an identifying region of the component.

6. The method of claim 5, wherein the surface roughness is inherent in the component after manufacture.

7. The method of claim 1, wherein at least one of the first component identifier and the second component identifier is a serial number additively manufactured onto a surface of the component.

8. The method of claim 1, wherein at least one of the first component identifier and the second component identifier is smaller than 50 micrometers such that it is not visible to the human eye.

9. The method of claim 1, wherein obtaining data indicative of the first component identifier comprises:
obtaining data indicative of an identifying region on the component, the identifying region containing the first component identifier of the component; and
interrogating the identifying region of the component with a scanner.

10. The method of claim 9, wherein the scanner is a laser and obtaining data indicative of the first component identifier comprises using the laser to optically scan the identifying region of the component.

11. The method of claim 9, wherein the scanner is a coordinate measuring machine and obtaining data indicative of the first component identifier comprises generating a topographical map of the identifying region using the coordinate measuring machine.

12. The method of claim 1, wherein the second component identifier is additively manufactured at a predetermined location relative to the first component identifier.

13. A system for authenticating an additively manufactured component, the system comprising:
one or more processors; and
one or more memory devices, the one or more memory devices storing computer-readable instructions that when executed by the one or more processors cause the one or more processors to perform operations, the operations comprising:
obtaining data indicative of a first component identifier of the component;
generating, using the first component identifier and an encryption key, a second component identifier; and
additively manufacturing the second component identifier onto the component.

14. The system of claim 14, wherein the operations further comprise recording the first component identifier and the second component identifier as an authenticating pair in a database.

15. The system of claim 15, wherein the operations further comprise:
receiving a validation identifier including data indicative of the first component identifier and the second component identifier; and
determining that the component is authentic if the validation identifier corresponds to the authenticating pair from the database.

16. The system of claim 13, wherein receiving data indicative of the first component identifier and the second component identifier comprises receiving the data from an end user or consumer.

17. A method of authenticating an additively manufactured component, the method comprising:
obtaining a first component identifier and a second component identifier of the component; and
determining that the component is authentic if the first component identifier and the second component identifier correspond to an authenticating pair from a database.

18. The method of claim 17, wherein determining that the component is authentic comprises:
communicating the first component identifier and the second component identifier to an authenticating entity, the authenticating entity having access to the database comprising a plurality of authenticating pairs; and
receiving an indication from the authenticating entity that the component is authentic if the first component identifier and the second component identifier correspond to one of the plurality of authenticating pairs.

19. The method of claim 17, wherein obtaining the first component identifier comprises:
obtaining data indicative of an identifying region on the component, the identifying region containing the first component identifier of the component; and
interrogating the identifying region of the component with a scanner.

20. The method of claim 19, wherein the scanner is a laser and obtaining data indicative of the first component identifier comprises using the laser to optically scan the identifying region of the component.
